(19) United States
(12) Patent Application Publication
(10) Pub. No.: US 2025/0007311 A1
(43) Pub. Date: Jan. 2, 2025

(54) STORAGE BATTERY CONTROL DEVICE, ELECTRIC POWER STORAGE SYSTEM, AND STORAGE BATTERY CONTROL METHOD

(71) Applicant: YAZAKI CORPORATION, Tokyo (JP)

(72) Inventor: Takahiro Syouda, Susono-shi (JP)

(21) Appl. No.: 18/886,980

(22) Filed: Sep. 16, 2024

Related U.S. Application Data
(63) Continuation of application No. PCT/JP2023/010458, filed on Mar. 16, 2023.

(30) Foreign Application Priority Data
Apr. 19, 2022 (JP) 2022-068747

(51) Int. Cl. H02J 7/00; H01M 10/44; H01M 50/51

(52) U.S. Cl. CPC H02J 7/00714; H01M 10/441; H01M 50/51; H02J 7/0016; H02J 2207/20

(57) ABSTRACT

A storage battery control device for controlling an electric power storage system includes a plurality of storage battery strings each including a plurality of storage batteries connected in series and connected by a power line, and a plurality of power converters each provided between the storage battery string and the power line and configured to convert an input and output voltage of the storage battery string. The number of the storage battery strings that perform discharge or charge is variably set according to a magnitude of discharge power or charge power of the electric power storage system. The number of the storage battery strings that perform discharge or charge is set such that a load factor of the power converter corresponding to the storage battery string that performs discharge or charge approaches a predetermined load factor at which power conversion efficiency of the power converter is maximized.

### CROSS-REFERENCE TO RELATED APPLICATIONS

This is a continuation of International Application No. PCT/JP2023/010458 filed on Mar. 16, 2023, and claims priority from Japanese Patent Application No. 2022-068747 filed on Apr. 19, 2022, the entire content of which is incorporated herein by reference.

### TECHNICAL FIELD

The present invention relates to a storage battery control device, an electric power storage system, and a storage battery control method.

### BACKGROUND ART

There is known a electric power storage system including a plurality of storage battery strings connected in parallel, and a plurality of direct current power converters provided for each of the storage battery strings and configured to convert an output of the storage battery string into a set voltage of a load supply bus (for example, see Patent Literature 1). In the electric power storage system disclosed in Patent Literature 1, the number of storage battery modules in the storage battery string is selected to any number.

### CITATION LIST

### Patent Literature

Patent Literature 1: JP2020-156200A

### SUMMARY OF INVENTION

### Technical Problem

In general, the power conversion efficiency of the power converter is set according to a maximum output power, increases as output power approaches the maximum output power, and decreases as the output power decreases. In contrast, in the electric power storage system described above, the number of storage battery strings that perform charge or discharge is constant. Therefore, in the electric power storage system, as discharge power or charge power becomes smaller, discharge power or charge power borne by each storage battery string becomes smaller, and power conversion efficiency of the power converter decreases. In addition, in the electric power storage system, since a certain number of power converters operate regardless of a magnitude of the power conversion efficiency, a total heat generation amount of the entire system may increase due to the operation of a certain number of power converters with low power conversion efficiency.

The present invention is made in view of the above circumstances, and an object thereof is to provide a storage battery control device, an electric power storage system, and a storage battery control method capable of maintaining power conversion efficiency of a power converter at high efficiency regardless of a magnitude of discharge power or charge power of the electric power storage system including a plurality of storage battery strings and a plurality of the power converters.

### Solution to Problem

A storage battery control device of the present invention is a storage battery control device for controlling an electric power storage system including a plurality of storage battery strings each including a plurality of storage batteries connected in series and connected by a power line, and a plurality of power converters each provided between the storage battery string and the power line and configured to convert an input and output voltage of the storage battery string, in which the number of the storage battery strings that perform discharge or charge is variably set according to a magnitude of discharge power or charge power of the electric power storage system, and the number of the storage battery strings that perform discharge or charge is set such that a load factor of the power converter corresponding to the storage battery string that performs discharge or charge approaches a predetermined load factor at which power conversion efficiency of the power converter is maximized.

An electric power storage system of the present invention is an electric power storage system including: a plurality of storage battery strings each including a plurality of storage batteries connected in series and connected by a power line; a plurality of power converters each provided between the storage battery string and the power line and configured to convert an input and output voltage of the storage battery string; and a storage battery control device configured to control the plurality of power converters, in which the storage battery control device variably sets the number of the storage battery strings that perform discharge or charge according to a magnitude of discharge power or charge power of the electric power storage system, and sets the number of the storage battery strings that perform discharge or charge such that a load factor of the power converter corresponding to the storage battery string that performs discharge or charge approaches a predetermined load factor at which power conversion efficiency of the power converter is maximized.

A storage battery control method of the present invention is a storage battery control method executed using a storage battery control device configured to control an electric power storage system including a plurality of storage battery strings each including a plurality of storage batteries connected in series and connected by a power line, and a plurality of power converters each provided between the storage battery string and the power line and configured to convert an input and output voltage of the storage battery string, the storage battery control method including: variably setting the number of the storage battery strings that perform discharge or charge according to a magnitude of discharge power or charge power of the electric power storage system; and setting the number of the storage battery strings that perform discharge or charge such that a load factor of the power converter corresponding to the storage battery string that performs discharge or charge approaches a predetermined load factor at which power conversion efficiency of the power converter is maximized.

### Advantageous Effects of Invention

According to the present invention, power conversion efficiency of the power converter can be maintained at high efficiency regardless of a magnitude of discharge power or charge power of the electric power storage system including the plurality of storage battery strings and the plurality of power converters.

### BRIEF DESCRIPTION OF DRAWINGS

FIG. 1 is a circuit diagram schematically showing an electric power storage system including a micro controller unit (MCU) and a system controller according to one embodiment of the present invention.

FIG. 2 is a flowchart showing processing during discharge by the MCU and the system controller in FIG. 1.

FIG. 3 is a flowchart showing processing during charge by the MCU and the system controller in FIG. 1.

### DESCRIPTION OF EMBODIMENTS

Hereinafter, the present invention will be described with reference to a preferred embodiment. The present invention is not limited to the embodiment to be described below, and the embodiment can be appropriately modified without departing from the scope of the present invention. In the embodiment to be described below, a part of configurations may be not described or shown in the drawings, and regarding details of the omitted techniques, publicly known or well-known techniques will be appropriately applied as long as there is no contradiction with the contents to be described below.

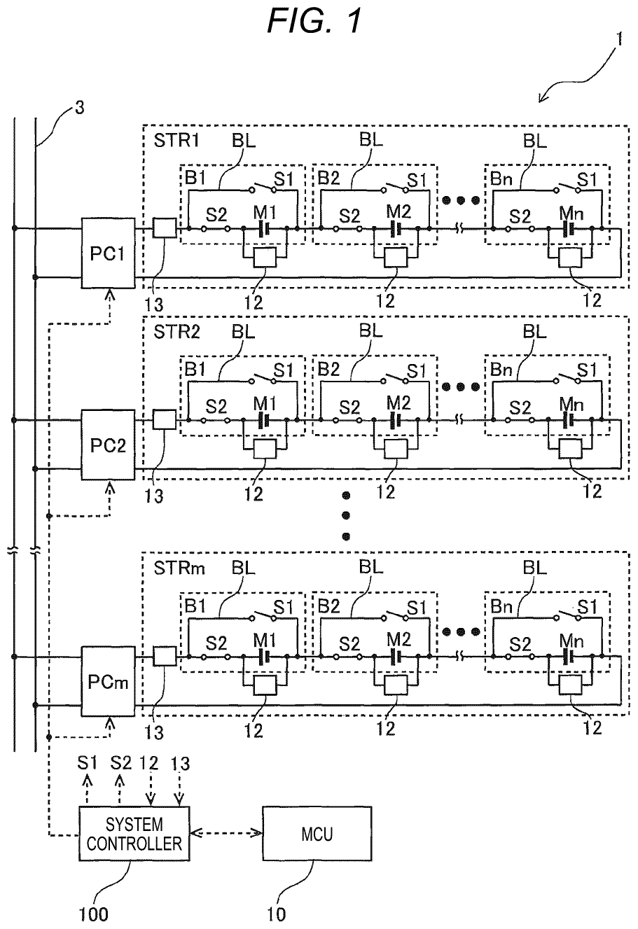

FIG. 1 is a circuit diagram showing an outline of an electric power storage system 1 including an MCU 10 and a system controller 100 according to one embodiment of the present invention. As shown in this drawing, the electric power storage system 1 includes m (m is an integer of 2 or more) sets of storage battery strings STR1 to STRm, a string bus 3, m power converters PC1 to PCm, the MCU 10, and the system controller 100. The m sets of storage battery strings STR1 to STRm are connected to one another via the m power converters PC1 to PCm and the string bus 3 and are connected to an external system (not shown). The electric power storage system 1 is a stationary or in-vehicle power supply.

The storage battery strings STR1 to STRm each include n (n is an integer of 2 or more) storage battery modules M1 to Mn connected in series. Although not particularly limited, the storage battery strings STR1 to STRm according to the present embodiment are obtained by regenerating used storage batteries, and a deterioration degree differs among the storage battery modules M1 to Mn. The storage battery modules M1 to Mn are secondary batteries such as lithium ion batteries or lithium ion capacitors.

The storage battery modules M1 to Mn are charged with power supplied from the external system through the string bus 3 and power converters PC1 to PCm. The storage battery modules M1 to Mn discharge the power for charging through the power converters PC1 to PCm and the string bus 3 to supply the power to the external system. The storage battery modules M1 to Mn may be charged by being supplied with power from another storage battery strings STR1 to STRm through the string bus 3 and the power converters PC1 to PCm. The storage battery modules M1 to Mn may discharge the charged power and charge the storage battery modules M1 to Mn of another storage battery strings STR1 to STRm through the power converters PC1 to PCm and the string bus 3.

The external system includes a load, a generator, and the like. When the electric power storage system 1 is for stationary use, the load includes a household electrical appliance, a commercial power supply system, a liquid crystal indicator, a communication module, and the like, and the generator includes a photovoltaic power generation system and the like. In contrast, when the electric power storage system 1 is for in-vehicle use, the load includes a driving motor, an air conditioner, various in-vehicle electrical components, and the like. The driving motor serves as a load and also as a generator.

The storage battery strings STR1 to STRm may include n storage battery cells or storage battery packs connected in series instead of the n storage battery modules M1 to Mn connected in series. The electric power storage system 1 may include a bypass circuit that bypasses each storage battery cell or each storage battery pack.

The power converters PC1 to PCm are DC/DC converters or DC/AC converters, and are connected to the string bus 3. A positive electrode of the storage battery module M1 at a start end and a negative electrode of the storage battery module Mn at a terminal end are connected to each of the power converters PC1 to PCm.

When the storage battery strings STR1 to STRm are charged, the power converters PC1 to PCm convert a voltage received from the string bus 3 and output the converted voltage to a plurality of the storage battery modules M1 to Mn. In contrast, when the storage battery strings STR1 to STRm are discharged, the power converters PC1 to PCm convert the voltage received from the plurality of storage battery modules M1 to Mn and output the converted voltage to the string bus 3. When a current flowing through the string bus 3 is a direct current, the power converters PC1 to PCm are the DC/DC converters, and when the current flowing through the string bus 3 is an alternating current, the power converters PC1 to PCm are the DC/AC converters. When the current flowing through the string bus 3 is the alternating current, each of the power converters PC1 to PCm includes a synchronization unit that follows a change in an instantaneous value.

The power converters PC1 to PCm are set to maximize the power conversion efficiency when operating at a maximum value P_{MAX} of output power and a predetermined load factor Lr. Therefore, the power conversion efficiency of the power converters PC1 to PCm decreases as the output power decreases from the maximum value P_{MAX}. When a large number of power converters PC1 to PCm having low power conversion efficiency are operated to ensure desired output power, a total heat generation amount of the entire electric power storage system 1 increases.

The storage battery strings STR1 to STRm each include n voltage sensors 12, a current sensor 13, and n bypass circuits B1 to Bn. The voltage sensor 12 is connected between positive and negative electrode terminals of each of the storage battery modules M1 to Mn. The voltage sensor 12 measures an inter-terminal voltage of each of the storage battery modules M1 to Mn.

The current sensor 13 is provided in a current path of the storage battery strings STR1 to STRm. The current sensor 13 measures a charge and discharge current of the storage battery strings STR1 to STRm.

The bypass circuits B1 to Bn are set for each of the storage battery modules M1 to Mn. Each of the bypass circuits B1 to Bn includes a bypass line BL and switches S1 and S2. The bypass line BL is a power line that bypasses each of the storage battery modules M1 to Mn. The switch S1 is provided on the bypass line BL. The switch S1 is, for example, a mechanical switch. The switch S2 is provided between a positive electrode of each of the storage battery modules M1 to Mn and one end of the bypass line BL. The switch S2 is, for example, a semiconductor switch or a relay.

The storage battery module M1 at the start end and the storage battery module Mn at the terminal end are connected to the external system via each of the power converters PC1 to PCm and the string bus 3. When the switches SI are opened and the switches S2 are closed in all the bypass circuits B1 to Bn, all the storage battery modules M1 to Mn are connected in series to the external system. In contrast, when the switches S2 are opened and the switches S1 are closed in any one of the bypass circuits B1 to Bn, the storage battery modules M1 to Mn corresponding to the bypass circuits B1 to Bn are bypassed.

The system controller 100 is connected to the storage battery strings STR1 to STRm, the bypass circuits B1 to Bn, and the power converters PC1 to PCm. The system controller 100 executes monitoring and control for the storage battery modules M1 to Mn, switching control for the bypass circuits B1 to Bn, and charge and discharge control by the power converters PC1 to PCm.

When the electric power storage system 1 is discharged, voltages of the storage battery strings STR1 to STRm fluctuate according to state of charges (SOCs) or bypass states (the number of connected storage battery modules M1 to Mn) of the storage battery modules M1 to Mn. Therefore, the power converters PC1 to PCm adjust output voltages such that the voltages of the storage battery strings STR1 to STRm that perform discharge match. In contrast, when the electric power storage system 1 is charged, the voltages of the storage battery strings STR1 to STRm fluctuate according to the SOCs or the bypass states of the storage battery modules M1 to Mn. Therefore, the power converters PC1 to PCm adjust voltages received from the string bus 3 to the voltages of the corresponding storage battery strings STR1 to STRm. That is, the system controller 100 controls the power converters PC1 to PCm according to a magnitude of the voltages of the storage battery strings STR1 to STRm.

In addition, the MCU 10 sets the number of storage battery strings STR1 to STRm that perform discharge or charge according to a magnitude of input and output power of the electric power storage system 1, and determines the storage battery strings STR1 to STRm that perform discharge or charge. The MCU 10 sets the number of storage battery strings STR1 to STRm that perform discharge or charge based on battery temperature information and battery state information such as SOC information received from the system controller 100, and determines the storage battery strings STR1 to STRm that perform discharge or charge.

The system controller 100 controls the power converters PC1 to PCm to operate the storage battery strings STR1 to STRm of the number set by the MCU 10 and to operate the storage battery strings STR1 to STRm determined by the MCU 10. Hereinafter, a control method of the power converters PC1 to PCm by the MCU 10 and the system controller 100 will be described.

In response to a command from the MCU 10, the system controller 100 controls the power converters PC1 to PCm to output or receive the power required for the electric power storage system 1. Prior to this, the MCU 10 sets the number of storage battery strings STR1 to STRm that perform discharge according to a magnitude of the output power required for the electric power storage system 1. In addition, the MCU 10 sets the number of storage battery strings STR1 to STRm that perform charge according to a magnitude of input power required for the electric power storage system 1.

For example, it is assumed that the power converters PC1 to PCm operate with maximum power conversion efficiency under conditions that the maximum value P_{MAX} of the output power=10 kW and the predetermined load factor Lr=80%. In addition, it is assumed that the number of sets of storage battery strings STR1 to STRm is 10 (m=10). Under these assumptions, a case will be described in which an output P_{OUT} of the electric power storage system 1 is 40 kW and all of the ten sets of storage battery strings STR1 to STRm are caused to perform discharge. In this case, the discharge power of each of the storage battery strings STR1 to STRm is 4 kW, and the load factor of each of the power converters PC1 to PCm is 40%. Therefore, the power converters PC1 to PCm cannot be operated with the maximum power conversion efficiency.

In contrast, under the assumptions described above, a case will be described in which the output P_{OUT} of the electric power storage system 1 is similarly 40 kW, and five sets of the storage battery strings STR1 to STRm are caused to perform discharge. In this case, the discharge power of each of the storage battery strings STR1 to STRm that perform discharge is 8 kW, and the load factors of the power converters PC1 to PCm corresponding to the storage battery strings STR1 to STRm that perform discharge is 80%. Accordingly, the power converters PC1 to PCm corresponding to the storage battery strings STR1 to STRm that perform discharge can be operated with the maximum power conversion efficiency.

Under the same assumptions, a case will be described in which an input P_{IN} of the electric power storage system 1 is 40 kW and all of the ten sets of storage battery strings STR1 to STRm are caused to perform charge. In this case, the charge power of each of the storage battery strings STR1 to STRm is 4 kW, and the load factor of each of the power converters PC1 to PCm is 40%. Therefore, the power converters PC1 to PCm cannot be operated with the maximum power conversion efficiency.

In contrast, under the assumptions described above, a case will be described in which the input P_{IN} of the electric power storage system 1 is 40 kW, and five sets of the storage battery strings STR1 to STRm are caused to perform charge. In this case, the charge power of each of the storage battery strings STR1 to STRm that perform charge is 8 kW, and the load factors of the power converters PC1 to PCm corresponding to the storage battery strings STR1 to STRm that perform charge is 80%. Accordingly, the power converters PC1 to PCm corresponding to the storage battery strings STR1 to STRm that perform charge can be operated with the maximum power conversion efficiency.

In contrast, for example, under the assumptions described above, a case will be described in which the output P_{OUT} of the electric power storage system 1 is 80 kW and all of the ten sets of storage battery strings STR1 to STRm are caused to perform discharge. In this case, the discharge power of each of the storage battery strings STR1 to STRm that perform discharge is 8 kW, and the load factors of the power converters PC1 to PCm corresponding to the storage battery strings STR1 to STRm that perform discharge is 80%. Accordingly, all the power converters PC1 to PCm can be operated with the maximum power conversion efficiency.h

Further, a case will be described in which the input P_{IN} of the electric power storage system 1 is 80 kW and all of the ten sets of storage battery strings STR1 to STRm are caused to perform charge. In this case, the charge power of each of the storage battery strings STR1 to STRm is 8 kW, and the load factors of the power converters PC1 to PCm corresponding to the storage battery strings STR1 to STRm that perform charge is 80%. Accordingly, all the power converters PC1 to PCm can be operated with the maximum power conversion efficiency.

Therefore, the MCU 10 variably sets the number of storage battery strings STR1 to STRm that perform discharge or charge according to the magnitude of the input and output power required for the electric power storage system 1. Specifically, the number of storage battery strings STR1 to STRm that perform discharge or charge is set such that the load factors of the power converters PC1 to PCm corresponding to the storage battery strings STR1 to STRm that perform discharge or charge approach the predetermined load factor Lr at which the power conversion efficiency is maximized.

Here, discharge currents or charge currents of the storage battery modules M1 to Mn of each of the storage battery strings STR1 to STRm may be limited. Examples of the limit include a case in which temperatures of the storage battery modules M1 to Mn are equal to or higher than a predetermined temperature, a case in which the storage battery modules M1 to Mn are discharged in a state close to full discharge (when the SOC is equal to or less than a predetermined value), and a case in which the storage battery modules M1 to Mn are charged in a state close to full charge (when the SOC is equal to or larger than the predetermined value).

When the discharge currents or the charge currents of the storage battery modules M1 to Mn are limited in this way, the MCU 10 receives a current limit value from the system controller 100. For the storage battery strings STR1 to STRm whose discharge currents or charge currents are not limited, the MCU 10 sets the discharge power or the charge power such that the load factors of the corresponding power converters PC1 to PCm are the predetermined load factor Lr at which the power conversion efficiency is maximized. In contrast, for the storage battery strings STR1 to STRm whose discharge currents or charge currents are limited, the MCU 10 sets the discharge power or the charge power by prioritizing limiting the discharge current or the charge current to the current limit value or less over increasing the load factors of the corresponding power converters PC1 to PCm.

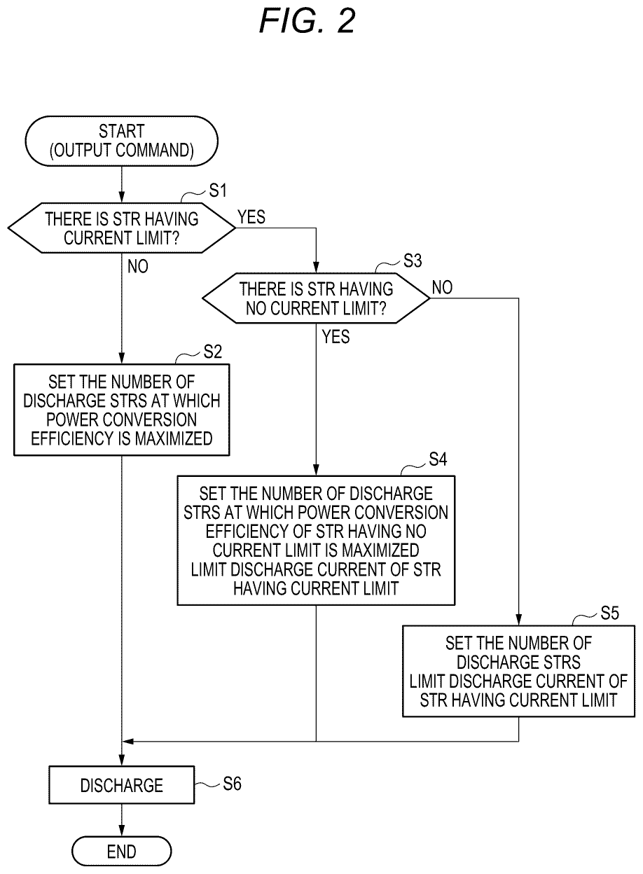

FIG. 2 is a flowchart showing processing during the discharge by the MCU 10 and the system controller 100 in FIG. 1. The processing shown in the flowchart in FIG. 2 is started when the MCU 10 receives an output command.

In step S1, the MCU 10 determines whether there is any storage battery strings STR1 to STRm having a current limit. If the determination is yes in step S1, the processing proceeds to step S3, and if the determination is no in step S1, the processing proceeds to step S2.

In step S2, the MCU 10 determines the number of storage battery strings STR1 to STRm that perform discharge and the storage battery strings STR1 to STRm that perform discharge according to the requested output power. In the present step, the number of storage battery strings STR1 to STRm that perform discharge is set such that the load factors of the power converters PC1 to PCm corresponding to the storage battery strings STR1 to STRm that perform discharge are the predetermined load factor Lr at which the power conversion efficiency is maximized. Then, the processing proceeds from step S2 to step S6.

In contrast, in step S3, the MCU 10 determines whether there is any storage battery strings STR1 to STRm having no current limit. If the determination is yes in step S3, the processing proceeds to step S4, and if the determination is no in step S3, the processing proceeds to step S5.

In step S4, the MCU 10 determines the number of storage battery strings STR1 to STRm that perform discharge and the storage battery strings STR1 to STRm that perform discharge according to the requested output power. In the present step, the number of storage battery strings STR1 to STRm that perform discharge in a state of having no current limit is set such that the load factors of the power converters PC1 to PCm corresponding to the storage battery strings STR1 to STRm that perform discharge are the predetermined load factor Lr at which the power conversion efficiency is maximized. On the other hand, for the storage battery strings STR1 to STRm that perform discharge in a state of having a current limit, the discharge current is set to be equal to or less than the current limit value, and the load factors of the corresponding power converters PC1 to PCm are also set according to the current limit value. Then, the processing proceeds from step S4 to step S6.

In contrast, in step S5, the MCU 10 determines the number of storage battery strings STR1 to STRm that perform discharge and the storage battery strings STR1 to STRm that perform discharge according to the requested output power. In the present step, for the storage battery strings STR1 to STRm that perform discharge, the discharge current is set to be equal to or less than the current limit value, and the load factors of the corresponding power converters PC1 to PCm are also set according to the current limit value. Then, the processing proceeds from step S5 to step S6.

In step S6, the system controller 100 controls the power converters PC1 to PCm to cause the storage battery strings STR1 to STRm determined by the MCU 10 to perform discharge. This completes the processing.

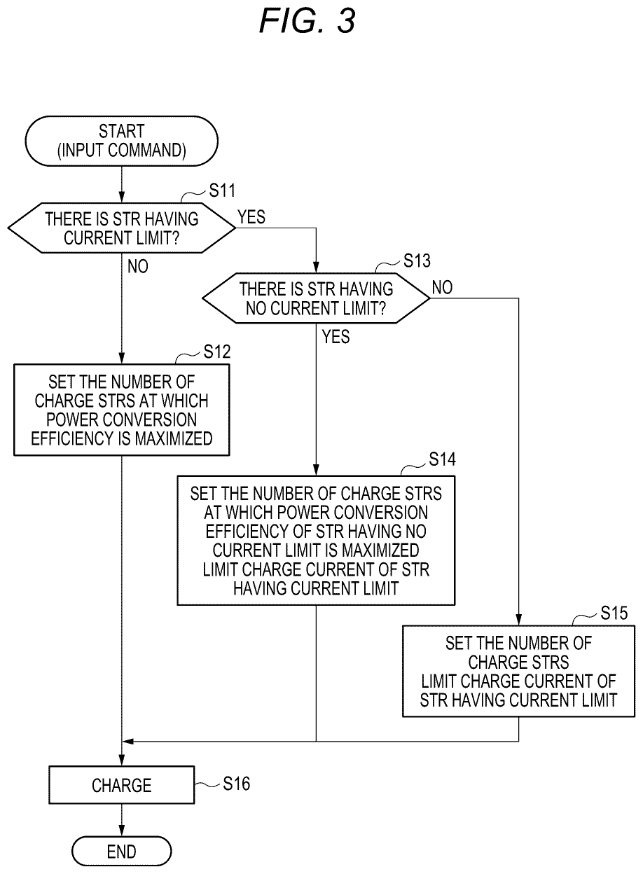

FIG. 3 is a flowchart showing processing during the charge by the MCU 10 and the system controller 100 in FIG. 1. The processing shown in the flowchart in FIG. 3 is started when the MCU 10 receives an input command.

In step S11, the MCU 10 determines whether there is any storage battery strings STR1 to STRm having a current limit. If the determination is yes in step S11, the processing proceeds to step S13, and if the determination is no in step S11, the processing proceeds to step S12.

In step S12, the MCU 10 determines the number of storage battery strings STR1 to STRm that perform charge and the storage battery strings STR1 to STRm that perform charge according to the requested input power. In the present step, the number of storage battery strings STR1 to STRm that perform charge is set such that the load factors of the power converters PC1 to PCm corresponding to the storage battery strings STR1 to STRm that perform charge are the predetermined load factor Lr at which the power conversion efficiency is maximized. Then, the processing proceeds from step S12 to step S16.

In contrast, in step S13, the MCU 10 determines whether there is any storage battery strings STR1 to STRm having no current limit. If the determination is yes in step S13, the processing proceeds to step S14, and if the determination is no in step S13, the processing proceeds to step S15.

In step S14, the MCU 10 determines the number of storage battery strings STR1 to STRm that perform charge and the storage battery strings STR1 to STRm that perform charge according to the requested input power. In the present step, the number of storage battery strings STR1 to STRm that perform charge is set such that the load factors of the power converters PC1 to PCm corresponding to the storage battery strings STR1 to STRm that perform charge in a state of having no current limit are the predetermined load factor Lr at which the power conversion efficiency is maximized. On the other hand, for the storage battery strings STR1 to STRm that perform charge in a state of having a current limit, the charge current is set to be equal to or less than the current limit value, and the load factors of the corresponding power converters PC1 to PCm are also set according to the current limit value. Then, the processing proceeds from step S14 to step S16.

In contrast, in step S15, the MCU 10 determines the number of storage battery strings STR1 to STRm that perform charge and the storage battery strings STR1 to STRm that perform charge according to the requested input power. In the present step, for the storage battery strings STR1 to STRm that perform charge, the charge current is set to be equal to or less than the current limit value, and the load factors of the corresponding power converters PC1 to PCm are also set according to the current limit value. Then, the processing proceeds from step S15 to step S16.

In step S16, the system controller 100 controls the power converters PC1 to PCm to cause the storage battery strings STR1 to STRm determined by the MCU 10 to perform charge. This completes the processing.

As described above, the MCU 10 of the present embodiment variably sets the number of storage battery strings STR1 to STRm that perform discharge according to the magnitude of the discharge power of the electric power storage system 1. Specifically, the MCU 10 sets the number of storage battery strings STR1 to STRm that perform discharge such that the load factors of the power converters PC1 to PCm corresponding to the storage battery strings STR1 to STRm that perform discharge approach the predetermined load factor Lr at which the power conversion efficiency of the power converters PC1 to PCm is maximized. Accordingly, the power conversion efficiency of the power converters PC1 to PCm corresponding to the storage battery strings STR1 to STRm that perform discharge can be maintained at high efficiency regardless of the magnitude of the discharge power of the electric power storage system 1. Therefore, the efficiency at the time of discharge of the electric power storage system 1 can be improved. In addition, a total heat generation amount of the entire electric power storage system 1 during discharge can be reduced, and the cost for cooling the electric power storage system 1 can be reduced.

The MCU 10 of the present embodiment variably sets the number of the storage battery strings STR1 to STRm that perform charge according to the magnitude of the charge power of the electric power storage system 1. Specifically, the MCU 10 sets the number of storage battery strings STR1 to STRm that perform charge such that the load factors of the power converters PC1 to PCm corresponding to the storage battery strings STR1 to STRm that perform charge approach the predetermined load factor Lr at which the power conversion efficiency of the power converters PC1 to PCm is maximized. Accordingly, the power conversion efficiency of the power converters PC1 to PCm corresponding to the storage battery strings STR1 to STRm that perform charge can be maintained at high efficiency regardless of the magnitude of the charge power of the electric power storage system 1. Therefore, the efficiency at the time of charge of the electric power storage system 1 can be improved. In addition, a total heat generation amount of the entire electric power storage system 1 during charge can be reduced, and the cost for cooling the electric power storage system I can be reduced.

The MCU 10 of the present embodiment sets the number of storage battery strings STR1 to STRm that perform discharge such that the load factors of the power converters PC1 to PCm corresponding to the storage battery strings STR1 to STRm that perform discharge under a condition that the discharge current is not limited approach the predetermined load factor Lr at which the power conversion efficiency is maximized. Meanwhile, the MCU 10 sets the load factors of the power converters PC1 to PCm corresponding to the storage battery strings STR1 to STRm that perform discharge under a condition that the discharge current is limited to be lower than those of the power converters PC1 to PCm corresponding to the storage battery strings STR1 to STRm that perform discharge under the condition that the discharge current is not limited. Accordingly, it is possible to maintain the power conversion efficiency of the power converters PC1 to PCm corresponding to the storage battery strings STR1 to STRm in which the discharge current is not limited at high efficiency while preventing the deterioration of the storage battery modules M1 to Mn in which the discharge current is limited.

The MCU 10 of the present embodiment sets the number of storage battery strings STR1 to STRm that perform charge such that the load factors of the power converters PC1 to PCm corresponding to the storage battery strings STR1 to STRm that perform charge under a condition that the charge current is not limited approach the predetermined load factor Lr at which the power conversion efficiency is maximized. Meanwhile, the MCU 10 sets the load factors of the power converters PC1 to PCm corresponding to the storage battery strings STR1 to STRm that perform charge under a condition that the charge current is limited to be lower than those of the power converters PC1 to PCm corresponding to the storage battery strings STR1 to STRm that perform charge under the condition that the charge current is not limited. Accordingly, it is possible to maintain the power conversion efficiency of the power converters PC1 to PCm corresponding to the storage battery strings STR1 to STRm in which the charge current is not limited at high efficiency while preventing the deterioration of the storage battery modules M1 to Mn in which the charge current is limited.

In the electric power storage system 1 of the present embodiment, the storage battery strings STR1 to STRm each include the bypass circuits B1 to Bn that bypass the storage battery modules M1 to Mn. As bypass of the storage battery modules M1 to Mn is generated by the bypass circuits B1 to Bn, the voltages of the storage battery strings STR1 to STRm fluctuate. For this, based on the control of the power converters PC1 to PCm, the system controller 100 matches the output voltages of the plurality of storage battery strings STR1 to STRm regardless of variations in the voltages of the storage battery strings STR1 to STRm. In contrast, by controlling the power converters PC1 to PCm, the system controller 100 causes the voltage input to each of the storage battery strings STR1 to STRm to match with the voltage of each of the storage battery strings STR1 to STRm regardless of the fluctuation of the voltage of each of the storage battery strings STR1 to STRm.

Although the present invention has been described above based on the above embodiment, the present invention is not limited to the above embodiment, modifications may be made without departing from the gist of the present invention, and publicly known or well-known techniques may be appropriately combined.

For example, in the embodiment described above, the number of storage battery strings STR1 to STRm that perform discharge or charge is set such that the power conversion efficiency of the power converters PC1 to PCm corresponding to the storage battery strings STR1 to STRm that perform discharge or charge is maximized. Here, it is preferable that the power conversion efficiency of the power converters PC1 to PCm corresponding to the storage battery strings STR1 to STRm that perform discharge or charge is close to the maximum power conversion efficiency as much as possible. It is preferable that the load factors of the power converters PC1 to PCm is close to the predetermined load factor Lr as much as possible, which is an optimum value. However, the power conversion efficiency of the power converters PC1 to PCm is not necessarily approximate to a maximum value, and may be appropriately set according to required performances of the electric power storage system 1. Further, the load factors of the power converters PC1 to PCm are not necessarily approximate to the predetermined load factor Lr which is an optimum value, and may be appropriately set according to the required performances of the electric power storage system 1.

In the embodiment described above, the storage battery strings STR1 to STRm each include the bypass circuits B1 to Bn. However, for example, when battery characteristics of the storage battery modules M1 to Mn are highly uniform, the bypass circuits B1 to Bn are not essentially included.

Here, features of embodiments of the storage battery control device, electric power storage system, and storage battery control method according to the present invention described above will be briefly summarized and listed in the following [1] to [5].
[1] A storage battery control device (10, 100) for controlling an electric power storage system (1) including
   a plurality of storage battery strings (STR1 to STRm) each including a plurality of storage batteries (M1 to Mn) connected in series and connected by a power line (3), and
   a plurality of power converters (PC1 to PCm) each provided between the storage battery string (STR1 to STRm) and the power line (3) and configured to convert an input and output voltage of the storage battery string (STR1 to STRm), in which
the number of the storage battery strings (STR1 to STRm) that perform discharge or charge is variably set according to a magnitude of discharge power or charge power of the electric power storage system (1), and
the number of the storage battery strings (STR1 to STRm) that perform discharge or charge is set such that a load factor of the power converter (PC1 to PCm) corresponding to the storage battery string (STR1 to STRm) that performs discharge or charge approaches a predetermined load factor (Lr) at which power conversion efficiency of the power converter (PC1 to PCm) is maximized.
[2] The storage battery control device (10, 100) according to [1], in which
the number of the storage battery strings (STR1 to STRm) that perform discharge or charge is set such that a load factor of the power converter (PC1 to PCm) corresponding to the storage battery string (STR1 to STRm) that performs discharge or charge under a condition in which a discharge current or a charge current is not limited approaches the predetermined load factor (Lr), and
a load factor of the power converter (PC1 to PCm) corresponding to the storage battery string (STR1 to STRm) that performs discharge or charge under a condition in which the discharge current or the charge current is limited is set to be lower than the load factor of the power converter (PC1 to PCm) corresponding to the storage battery string (STR1 to STRm) that performs discharge or charge under the condition in which the discharge current or the charge current is not limited.
[3] The storage battery control device (10, 100) according to [1] or [2], in which the storage battery string (STR1 to STRm) includes a bypass circuit (B1 to Bn) configured to bypass the storage battery (M1 to Mn).
[4] An electric power storage system (1) including:
a plurality of storage battery strings (STR1 to STRm) each including a plurality of storage batteries (M1 to Mn) connected in series and connected by a power line (3);
a plurality of power converters (PC1 to PCm) each provided between the storage battery string (STR1 to STRm) and the power line (3) and configured to convert an input and output voltage of the storage battery string (STR1 to STRm); and
a storage battery control device (10, 100) configured to control the plurality of power converters (PC1 to PCm), in which
the storage battery control device (10, 100) variably sets the number of the storage battery strings (STR1 to STRm) that perform discharge or charge according to a magnitude of discharge power or charge power of the electric power storage system (1), and
sets the number of the storage battery strings (STR1 to STRm) that perform discharge or charge such that a load factor of the power converter (PC1 to PCm) corresponding to the storage battery string (STR1 to STRm) that performs discharge or charge approaches a predetermined load factor (Lr) at which power conversion efficiency of the power converter (PC1 to PCm) is maximized. [5]
[5] A storage battery control method executed using a storage battery control device (10, 100) configured to control an electric power storage system (1) including
   a plurality of storage battery strings (STR1 to STRm) each including a plurality of storage batteries (M1 to Mn) connected in series and connected by a power line (3), and
   a plurality of power converters (PC1 to PCm) each provided between the storage battery string (STR1 to STRm) and the power line (3) and configured to convert an input and output voltage of the storage battery string (STR1 to STRm),
the storage battery control method including:
   variably setting the number of the storage battery strings (STR1 to STRm) that perform discharge or charge according to a magnitude of discharge power or charge power of the electric power storage system (1); and
setting the number of the storage battery strings (STR1 to STRm) that perform discharge or charge such that a load factor of the power converter (PC1 to PCm) corresponding to the storage battery string (STR1 to STRm) that performs discharge or charge approaches a predetermined load factor (Lr) at which power conversion efficiency of the power converter (PC1 to PCm) is maximized.

Although the present invention has been described in detail with reference to the specific embodiments, it is apparent to those skilled in the art that various changes and modifications can be made without departing from the spirit and scope of the present invention.

The present application is based on a Japanese patent application (Japanese Patent Application No. 2022-068747) filed on Apr. 19, 2022, and the contents thereof are incorporated herein by reference.

### INDUSTRIAL APPLICABILITY

According to the present invention, a storage battery control device, an electric power storage system, and a storage battery control method capable of maintaining power conversion efficiency of a power converter at high efficiency regardless of a magnitude of discharge power or charge power of the electric power storage system including a plurality of storage battery strings and a plurality of the power converters. The present invention having this effect is useful for the storage battery control device, the electric power storage system, and the storage battery control method.

### REFERENCE SIGNS LIST

1: electric power storage system
3: string bus (power line)
10: MCU (storage battery control device)
100: system controller (storage battery control device)
B1 to Bn: bypass circuit
Lr: predetermined load factor
M1 to Mn: storage battery module (storage battery)
PC1 to PCm: power converter
STR1 to STRm: storage battery string

1. A storage battery control device for controlling an electric power storage system including
a plurality of storage battery strings each including a plurality of storage batteries connected in series and connected by a power line, and
a plurality of power converters each provided between the storage battery string and the power line and configured to convert an input and output voltage of the storage battery string, wherein:
the number of the storage battery strings that perform discharge or charge is variably set according to a magnitude of discharge power or charge power of the electric power storage system;
the number of the storage battery strings that perform discharge or charge is set such that a load factor of the power converter corresponding to the storage battery string that performs discharge or charge approaches a predetermined load factor at which power conversion efficiency of the power converter is maximized;
the number of the storage battery strings that perform discharge or charge is set such that a load factor of the power converter corresponding to the storage battery string that performs discharge or charge under a condition in which a discharge current or a charge current is not limited approaches the predetermined load factor; and
a load factor of the power converter corresponding to the storage battery string that performs discharge or charge under a condition in which the discharge current or the charge current is limited is set to be lower than the load factor of the power converter corresponding to the storage battery string that performs discharge or charge under the condition in which the discharge current or the charge current is not limited.

2. The storage battery control device according to claim 1, wherein the storage battery string includes a bypass circuit configured to bypass the storage battery.
